(19) United States
(12) Patent Application Publication
(10) Pub. No.: US 2007/0290787 A1
(43) Pub. Date: Dec. 20, 2007

(54) Systems and methods for group messaging

(76) Inventors: Trevor Fiatal, Fremont, CA (US); Atif Hussein, Burlingame, CA (US); Jason Guesman, Los Altos Hills, CA (US)

Correspondence Address: CARR & FERRELL LLP, 2200 GENG ROAD, PALO ALTO, CA, 94303, US

(21) Appl. No.: 11/701,590

(22) Filed: Feb. 2, 2007

Related U.S. Application Data
(60) Provisional application No. 60/805,301, filed on Jun. 20, 2006.

(51) Int. Cl. H04Q 7/20

(52) U.S. Cl. 340/2.1

(57) ABSTRACT

Systems and methods for sending messages to a group using a preferred or an optimal communication medium for each individual in the group are provided. Groups may be indicated by tags associated with each individual in the group. Determining a preferred or optimal communication medium for each individual may be based on various factors, including predetermined preferences, presence, and/or activity. In various embodiments, the present invention includes systems and methods for managing a plurality of groups with overlapping membership.

### CROSS-REFERENCE TO RELATED APPLICATIONS

This application claims the priority benefit of U.S. provisional patent application No. 60/805,301 filed Jun. 20, 2006 and entitled “Communication and Content Sharing Across Social Networks.” The present application is related to co-pending U.S. patent application Ser. No. 11/363,912 filed Feb. 27, 2006 and entitled “Context Based Action.” The disclosures of these commonly owned and assigned applications are incorporated herein by reference.

### BACKGROUND OF THE INVENTION

1. Field of the Invention

The present invention relates to messaging. More specifically, the present invention relates to group messaging in the context of mobile devices such as cellular telephones, smart phones, personal data assistants (PDAs), wireless electronic mail devices, and the like.

2. Description of Related Art

An individual may send and receive messages in a variety of ways, including short message service (SMS) text messaging, instant messaging (IM), and/or electronic mail (e-mail). In some instances, an individual may utilize multiple SMS messaging services, IM services, and/or e-mail providers. The variety of available communication media in conjunction with multiple service offerings thereof offers the advantage of options and alternatives should any of the one or more of the media fail to provide prompt access to the individual. Notwithstanding, these multiple options for communicating with an individual complicate the decision-making process with regard to which communication media to use and when. When communicating with a group of individuals with different communication media and different preferences, decisions concerning communication media become even more complicated.

Some communication media presently allow for group messaging whereby an individual may send a message to a group of contacts. For example, e-mail services allow a user to send a message to a group of contacts by entering the name of each individual contact in a newly defined group or the individual contact may be added to a previously defined group or list of contacts. A list may be as simple as “everyone,” which includes every individual contact in the user's contacts database. Alternatively, the user may make custom lists for various groups of contacts, such as “family” for family members, “work” for work-related contacts, “soccer team” for soccer teammates, and “book club” for members of a book club. When an e-mail is addressed and sent to a particular group, that e-mail is automatically sent to each member of the group at that member's respective e-mail address.

Other communication media presently lack the functionality for group messaging. For example, SMS text messaging cannot be used to send a message to a group. SMS text messaging can generally only send a short text message from one device to one other device. If a user wishes to send an SMS text message to a group, the user must retype and separately send the message to each individual in the group.

Because a group of contacts may include individuals with various communication media and different preferences concerning those available communication media, communicating with that group becomes complicated. For example, some individuals in the group may not be able to receive text messages. Alternatively, one individual in a group may prefer being contacted by text message, while another prefers e-mail. There is, therefore, a need in the art for improved messaging with a group of individuals using each individual's preferred communication medium.

### SUMMARY OF THE INVENTION

Exemplary systems and methods of the present invention provide for transmitting messages from a mobile device to groups of contacts using a preferred communication medium for each contact. In various embodiments of the present invention, a message is composed on a user's mobile device, addressed to a group using a tag associated with the group, and sent to the group. Each group member receives the message through his/her preferred communication medium.

Various embodiments of the present invention include methods for group messaging using a mobile device. In an exemplary embodiment, a user may input a message into the user's mobile device. Further, the user may choose to address the message to a group by using a tag associated with one or more individuals. The mobile device determines a preferred or optimal communication medium for each individual associated with the tag and sends the message using the determined media.

Embodiments of the present invention include methods for using tags to manage a contacts database in a mobile device. Tags may be used shorthand indicators for a group of individuals. Using tags to address messages allows the user to send a message to the group using a communication medium determined to be preferred or optimal for each individual.

Various embodiments of the present invention include systems for group messaging, which may include input/output, contacts database, a processor, and a group messaging module. An exemplary implementation may include a user inputing a message and a tag associated with a group of individuals in the contacts database. The group messaging module, in conjunction with processor, uses information associated with each individual to determine a preferred or optimal communication medium to use for that individual.

Some embodiments of the present invention include computer media and instructions for group messaging involving the use of tags, where each individual associated with the tag can be messaged through a preferred or optimal communication medium.

### BRIEF DESCRIPTION OF FIGURES

FIG. 1 is an illustration of a mobile device that may be used in a group messaging system, in accordance with an exemplary embodiment of the present invention.

FIG. 2A is an illustration of a contacts database that may be used in a group messaging system, in accordance with an exemplary embodiment of the present invention.

FIG. 2B is an illustration of a contacts database sorted by contact, in accordance with an exemplary embodiment of the present invention.

FIG. 2C is an illustration of a contacts database sorted by tag, in accordance with an exemplary embodiment of the present invention.

FIG. 3 is an illustration of an implementation of a group messaging system, in accordance with an exemplary embodiment of the present invention.

FIG. 4 is a flowchart depicting a group messaging method, in accordance with an exemplary embodiment of the present invention.

### DETAILED DESCRIPTION

The present invention includes systems and methods for sending messages to a group using a preferred communication medium for each individual in the group. Determining a preferred communication medium for each individual may be based on various factors, including predetermined preferences, presence, and/or activity. In various embodiments, the present invention includes systems and methods for managing a plurality of groups with overlapping membership.

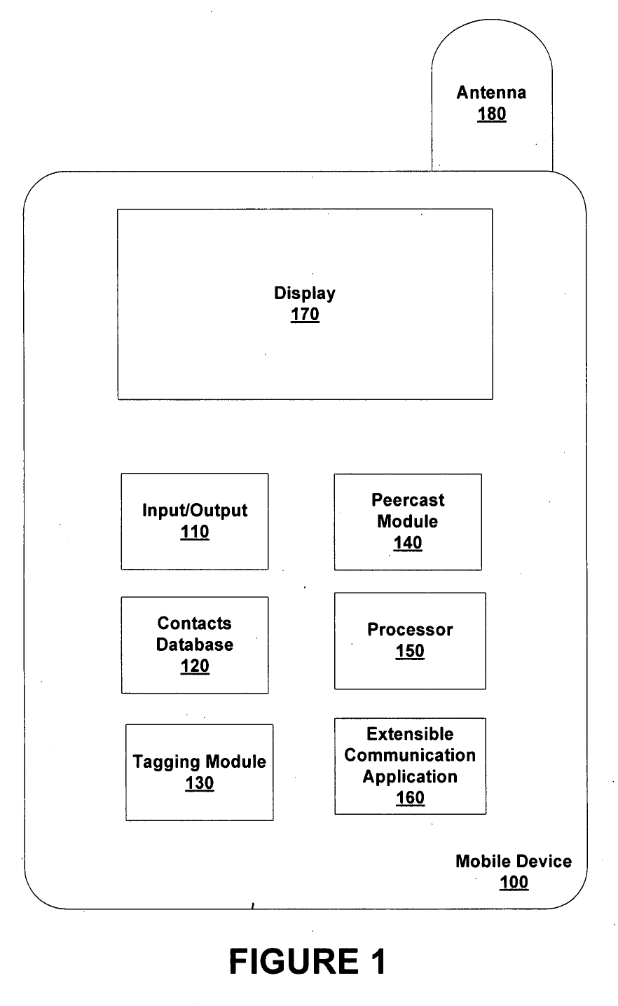

FIG. 1 is an illustration of an exemplary mobile device 100 that may be used in a group messaging system, according to various embodiments of the present invention. Mobile device 100 may include cellular telephones, smart phones, PDAs, wireless e-mail devices, handheld computers, and the like. In some embodiments of the present invention, mobile device 100 may comprise input/output component(s) 110, a contacts database 120, a tagging module 130, a peercast module 140, a processor 150, an extensible communication application 160, a display 170, and an antenna 180.

Input/output 110 may include any of a variety of hardware and/or software components configured to allow for communication between the user, other components of mobile device 100, and, in conjunction with antenna 180, other mobile devices. The communications may include audio/visual information, SMS text messages, IMs, and e-mail messages. Input/output 110 may include a keypad, keyboard, touchpad, touch screen, speech recognition applications, microphone, speakers, and the like. Some embodiments of the present invention may include one or more input/output 110 components operating individually or in combination with one another.

Contacts database 120 may be a database configured to store information regarding various contacts. Such contact information may include information concerning various communication media associated with each contact, including e-mail addresses, IM addresses, and SMS numbers/addresses. Information may be added, deleted, and edited in contacts database 120 using one or more input/output 110 components. For example, a keypad may be used to enter a new telephone number. Other examples may include automatic add options offered upon receipt of a phone call or message and synching operations performed by cable or wirelessly.

Personal preferences may be included in contacts database 120 in association with each personal contact entry. For example, a person may have a preference about which e-mail/IM addresses to use. That person may be more likely to check that particular e-mail/IM address more frequently than other communication media. Thus, using the preferred address may allow a person to receive messages more quickly than messages sent to another address via another medium. Further, a person may have different preferences based on the context of the message, which may be related to a group affiliation. For example, a person may prefer to receive work-related messages through e-mail and to receive soccer team-related messages through text messages.

Contacts database 120 may further include information concerning the various groups to which a contact belongs. Group affiliation may be indicated by tags. A tag, created and managed by tagging module 130, may be used by a user as shorthand indicator for all the individuals in the group. Tags may be used to send messages to groups, as well as to search and retrieve messages to or from members of groups. The tag may be stored in contacts database 120 and processed by, for example, processor 150 alone or in conjunction with other components and modules of mobile device 100.

As noted above, tags may also be used beyond identifying recipients for a message. Tags may be utilized as a form of predefined search. For example, based on specification of a tag, a user may be presented with all e-mail/SMS/IM/phone conversations to/from the set of contacts defined by that tag. In such an example, the tag may not immediately be used as a means to communicate a message to the tag-identified group. Peercast communication may nonetheless occur at some point in such a scenario. In this particular example, however, the tag may be used to produce a narrowly scoped search result, which may be useful and relevant in a specific context.

A module (or application), as referenced in the present invention, is a collection of routines that perform various system-level functions and may be dynamically loaded and unloaded by hardware and device drivers as required. The modular software components described herein may also be incorporated as part of a larger software platform or integrated as part of an application specific component.

Operating either independently or in conjunction with contacts database 120, tagging module 130 is configured to create and manage the various tags included in contacts database 120. Creating a tag using tagging module 130 may include receiving user input concerning the name of the tag and identifying the one or more individuals in the contacts database 120 that will be associated with the tag.

Tags may also be implicitly defined. Examples of implicitly defined tags may include tags for frequently used groups of contacts and for contacts that have been imported, along with categories, groups, “buddy lists,” and the like, from various sources. For example, usage-based tagging may include frequently called, e-mailed, I-M'd, or texted contacts. Contacts may also be imported from, replicated, or synced from a given source such as a contact from an address book. Further, categories may be inherited from an original data source such as a business or personal category in Microsoft Outlook. Such categories may be associated with tags and managed through tagging module 130.

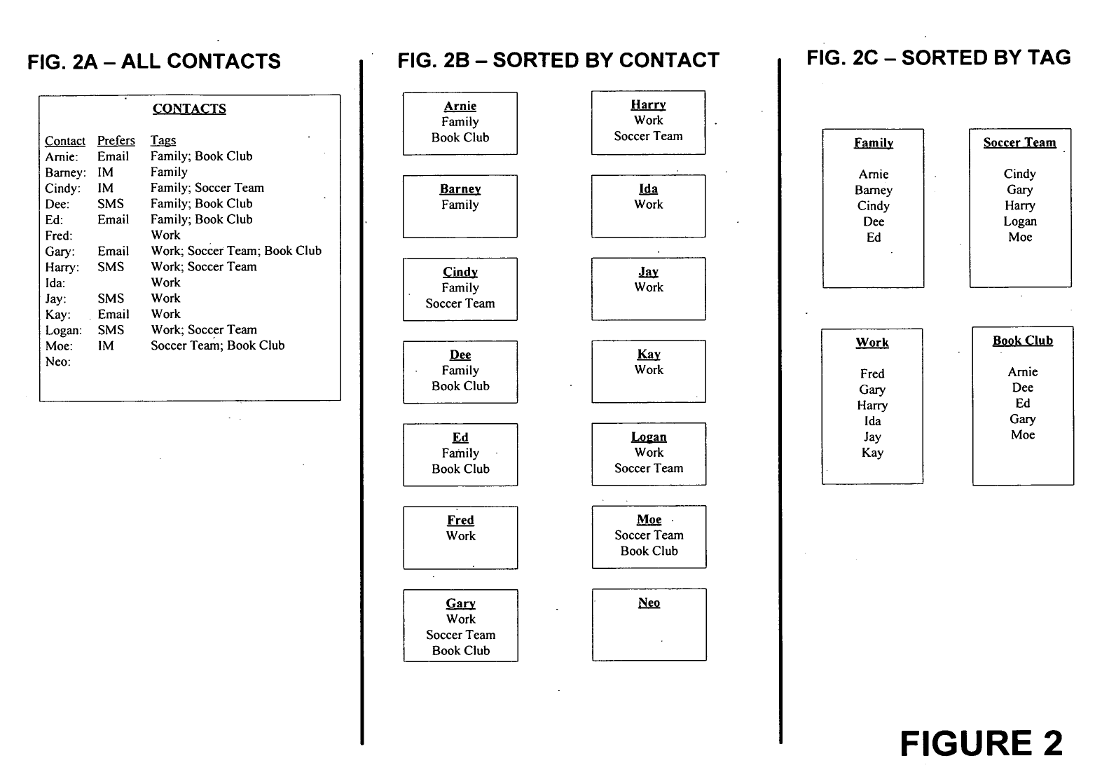

Tagging module 130 allows for the user to associate an individual contact with no tag, one tag, or a plurality of tags. Tagging module 130 may allow the user to sort the contacts database 120 by contact and/or by tag, as can be seen in FIG. 2. For example, a user may wish to send a message to all of the user's family members. Rather than individually looking up and/or typing out each family member's contact information, the user may simply address the message using the tag “Family.” Further, the tagging module 130 allows the user to retrieve various types of messages addressed to or from a certain group or individual. For example, a user may wish to review all communications exchanged with a group of work colleagues. Rather than searching every e-mail, IM, and SMS inbox individually, a user may simply retrieve a categorized list of communications exchanged with all contacts associated with the “Work” tag.

Peercast module 140 is configured to allow a user to send a message to a group of contacts using each contact's preferred communication medium. User input concerning content or recipient of a message may be received by peercast module 140 from input/output 110. Peercast module 140 may operate in conjunction with contacts database 120 and tagging module 130 to allow the user to address the message to a group using a tag. After the message is addressed using a tag, peercast module 140 sends the message to each individual in the group using that individual's preferred communication medium by operating in conjunction with extensible communications application 160 as detailed below.

Processor 150 is configured to execute a variety of operations. These operations include taking into account various kinds of information, such as preferences and presence, in determining a communication medium for reaching each individual. The likelihood of an individual promptly receiving a communication using a given communication medium depends on a variety of factors, including, for example, personal preferences, presence, and activity. As disclosed in U.S. patent application Ser. No. 11/607,620 titled “Location-Based Operations and Messaging,” filed Dec. 1, 2006 (the disclosure of which is incorporated by reference), processor 150 may use the individual's location as may be determined by GPS and/or A-GPS, to determine the communication medium most likely to be successful at contacting the individual. Processor 150 may use any of a variety of factors, independently or in conjunction with each other, to determine the most effective medium of communication for reaching the contact.

Processor 150 may determine a medium of communication based on factors such as predetermined personal preference. For example, one individual in a group may have a decided preference for receiving messages through e-mail while the other group members may prefer to receive messages through text messaging. Processor 150 may execute a variety of operations, including determining that e-mail should be used to reach the first individual and providing that information to peercast module 140, so that a message sent to this group in conjunction with extensible communication application 160 would use e-mail for the first individual and text messaging for the other individuals.

Alternatively, processor 150 may determine an effective medium of communication based on presence. For example, various communication media require that a message recipient turn on his/her mobile device, log in, sign in, or the like, in order to access a message. Such presence information may be received by mobile device 110 in a fashion like that described in U.S. patent application Ser. No. 11/363,912 and provided to processor 150, which may then use presence as a factor in determining which communication medium to use. For example, a group member may have indicated that e-mail is his/her preferred communication media, but that group member is not signed onto his/her e-mail service. That individual may, however, be signed onto his/her instant messaging service. In some embodiments of the present invention, the message may be sent to that individual by e-mail but the sender receives a notification concerning the recipient's lack of e-mail presence. The sender may alternatively or additionally receive information concerning the recipient's instant messaging presence. The presence information may also be presented to the user first, and the user may decide which communication medium to use. Determinations may also occur automatically.

Information concerning lack of activity on a given communication medium may also be received by mobile device 100. An individual may have signed onto a service but still may not be immediately accessible through that service. The user may receive a notification of an individual's lack of activity on a certain medium and then be given the option of sending the message to that individual again using an alternative communication medium.

For example, a user may want to send an urgent message to the user's soccer team concerning an upcoming game. That message may be sent using each team member's preferred communication medium. One team member may have indicated that instant messaging is her preferred communication medium and have signed onto her instant messaging service. Lack of IM activity for a prolonged period of time, however, may indicate that she is not currently monitoring her instant messages, so the user may wish to contact her by other means. The user may be notified of the lack of activity and be given various options concerning other communication media; The determination to use an alternative medium may also occur automatically.

Extensible communication application 160 allows for the use of a single mobile device 100 in efficiently managing multiple communication media (IM, SMS, e-mail, etc.). Allowing for integration and cross-platform interoperability, extensible communication application 160 further allows a user of mobile device 100 to access various communications media in a cumulative, integrated setting so that a user does not have to repeatedly authenticate to each individual service to be able to send and/or receive messages. Various embodiments of extensible communication application 160 allow for authentication and secure transmission for each communication medium. In various embodiments of the present invention, extensible communication application 160 further integrates various address books, contact lists such as those in contacts database 120, calendars, and the like. In an embodiment of the present invention, extensible communications application 160 may operate in conjunction with peercast module 140 and processor 150 to allow for delivery of messages to users utilizing a preferred communication medium.

Extensible communication application 160 may include any of a variety of software applications configured to integrate the variety of protocols and/or applications required to access various communications media via mobile device 100. Such protocols may include Internet Message Access Protocol (IMAP), Instant Message and Presence Service (IMPS), Session Initiation Protocol for Instant Messaging and Presence Leveraging Extensions (SIP/SIMPLE), Post Office Protocol 3 (POP3), Simple Mail Transfer Protocol (SMTP), Hypertext Transfer Protocol (HTTP), SMS, Internet Protocol (IP), Session Initiation Protocol (SIP) and the like.

Extensible software application 160 may be similar to that described in U.S. provisional patent application No. 60/805,301, which has previously been incorporated herein by reference. In some embodiments of the present invention, an extensible communications application 160 or other application offering similar functionality and that may assist in making communication media determinations may reside at a communication management server, as described in U.S. patent application Ser. No. 11/363,912, which has previously been incorporated herein by reference.

A variety of communication applications may be accessible and integrated with extensible communication application 160. For example, an individual may have multiple e-mail addresses, such as Yahoo!®, Gmail®, Microsoft® Outlook, and the like. An individual may have multiple IM addresses, such as Yahoo!® IM, America Online® (AOL) IM, Google Talk (GTalk™); ICQ and the like. Further, incorporating an application, such as Jabber® may enable increased interoperability with IM applications such as AOL/AIM, Yahoo!® IM, GTalk™, and various other communications protocols. Extensible communications application 160 may further operate in conjunction with input/output component 110.

By operating in conjunction with peercast module 140 and extensible communication application 160, display 170 may be configured to display a user environment through which various communications applications can be conveniently accessed and used to send messages. Display 170 may also operate in conjunction with contacts database 120 to display information for a contact. For example, when a user searches for a contact, the information concerning that contact's group affiliations and various communication media may be displayed by display 170. Display 170 may further reflect indications concerning the current presence, activity, and/or log-in status of the contact through each communication medium.

Antenna 180 may be configured to receive and transmit various electromagnetic waves, including, for example, radio signals. Various embodiments may include external antennas, internal antennas, wireless network antennas, and the like. The electromagnetic waves received and transmitted by antenna 180 may convey various kinds of information, including the communication information generated or received by input/output components 110.

FIG. 2A is an illustration of an exemplary contacts database 120 that may be used in a group messaging system, according to various embodiments of the present invention. Contacts database 120 and tagging module 130 may operate in conjunction to allow for the creation and management of the various groups significant to the user. For example, FIG. 2A illustrates an exemplary contacts database including information about various individuals. Such information may include communication media preferences and affiliation to groups such as family, work colleagues, soccer teammates, book club members, and others. Further, there may be overlap among the groups. For example, a family member may also be a soccer teammate, and a work colleague may also be a fellow book club member.

FIG. 2B is an illustration of an exemplary contacts database 120 sorted by contact, according to various embodiments of the present invention. The user may desire to view and/or search the contacts database 120 by contact. For example, a user may wish to send a message to an individual contact. Viewing that contact's group affiliations may allow the user to include, in the message, information concerning the various groups. Further, sorting by contact may facilitate the user's ability to view and edit an individual's group affiliations (i.e., adding or removing the individual from various groups).

FIG. 2C is an illustration of an exemplary contacts database 120 sorted by tag, according to various embodiments of the present invention. When a user wishes to send a message to a group, the user may search contacts database 120 for the tag associated with that group. For example, if the user is sending a message to family members, the user may search for that group's tag, which may appear as “Family” or be customized by user to appear as “Smith Family,” “The Brethren,” “My Clan,” or the like. Sorting by tag may further help a user to edit the membership of the various groups associated with the tag.

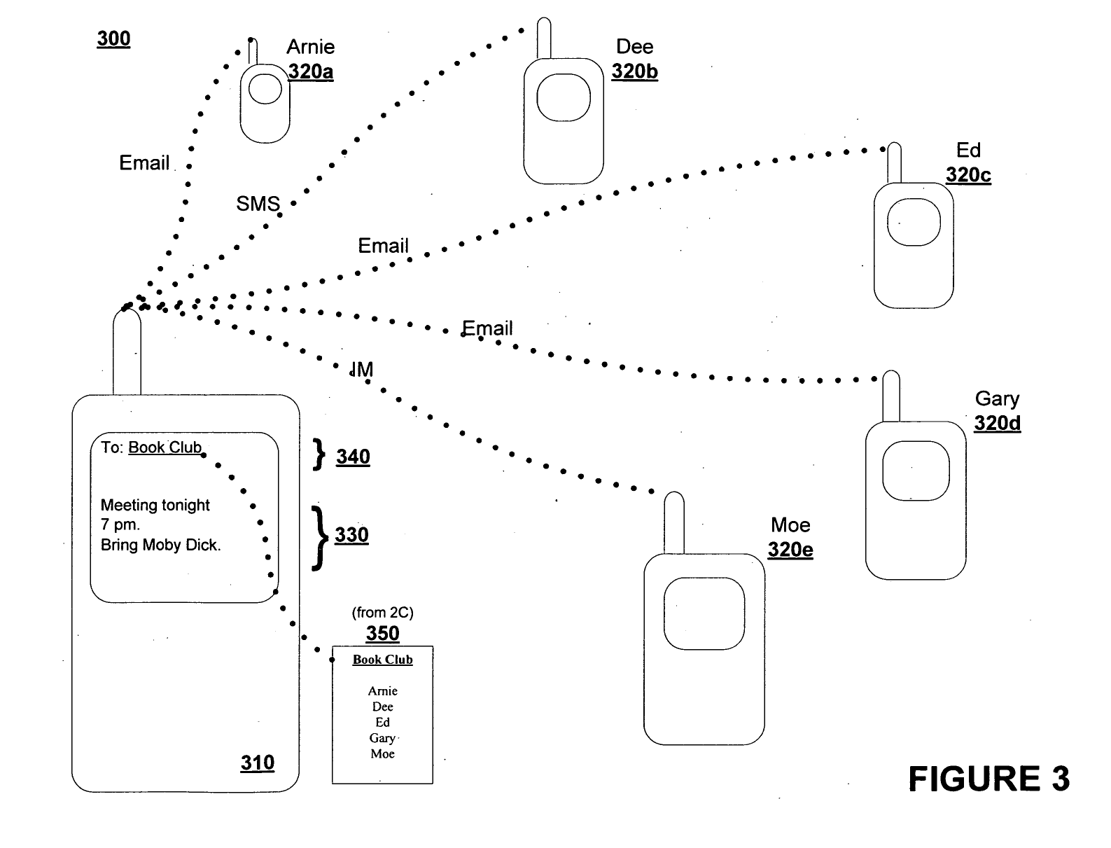

FIG. 3 is an illustration of an exemplary implementation of a group messaging system 300, according to various embodiments of the present invention. A sender's mobile device 310 sends a group message to recipient devices belonging to members of “Book Club,” using each member's preferred communication medium. Sender's mobile device 310 may include some or all of the components referenced with respect to mobile device 100, illustrated in FIG. 1. The recipient devices 320 may be mobile communication devices, like mobile device 100, with the ability to receive messages through various communication media. Recipient devices 320 may further include personal computers, laptop computers, cellular telephones, smart phones, PDAs, wireless e-mail devices, handheld computers, and the like.

As illustrated in FIG. 3, a sender may use sender's mobile device 310 to compose a message 330, address the message using a tag 340, and send that message to a group of contacts 350. The message is transmitted to recipient devices 320 belonging to the members of the book club. Further, the message is sent using the preferred communication medium of each group member. In the illustrated embodiment, the preferred communication media may be accessed by the intended recipients using their respective recipient devices 320. The message may be sent to one member's e-mail 320a and to another member's text messaging service 320b depending on user preferences or optimal communication media.

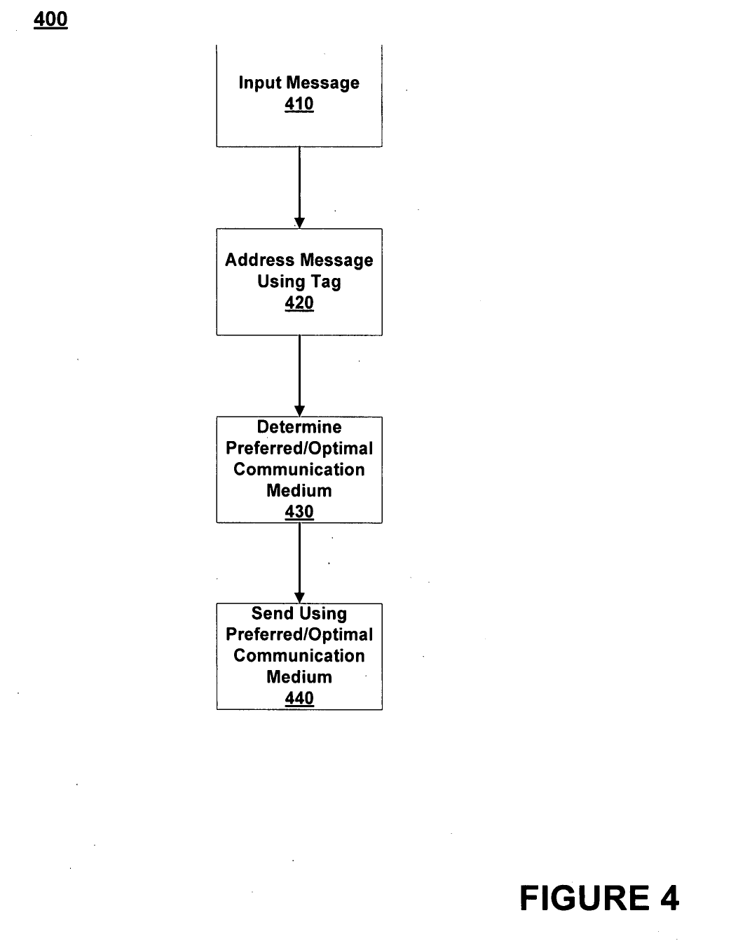

FIG. 4 is a flowchart depicting an exemplary group messaging method 400, according to various embodiments of the present invention. In this exemplary method 400, a message is input, addressed to a group of contacts, and sent to each contact using the contact's preferred or optimal communication medium.

In step 410, a user inputs a message into mobile device 100 using input/output component 110. Inputting a message may include composing various types of content, including text, images, sound, and/or the like. Extensible communication application 160 allows the user to compose messages that can be received and processed by various communication applications.

In step 420, the user addresses the message to a group of contacts by inputting a tag associated with the group. Inputting the tag may include searching contacts database 120, speaking into a speech recognition component, using preset speed-dial buttons, selecting from contacts database 120, and the like. Various embodiments of the present invention allow for a user to search for, speak, pre-set, and select the name of an individual or the tag of a group. Further, the user may search for an individual, view a list of that individual's group affiliations, and select a group from that list. The user may also use tagging module 130 to create, edit, and manage groups of contacts.

In step 430, a preferred or optimal communication medium is determined for each individual in the group. To determine a preferred communication medium for each individual, processor 150 takes various factors into account including predefined preferences. Optimal medium determination may include information related to log-in and/or activity status on various applications, log-in status on various devices, and the like. Some embodiments of the present invention may consider a combination of factors. Step 430 may also include utilizing various processes to weigh the various factors and determine which of the various communication media would be most effective (optimal) at reaching each individual.

Further, step 430 may include determining alternative communication media, based on various factors, including, for example, presence and/or activity. For example, e-mailing may be a contact's preferred communication medium, then in descending order, instant messaging, text messaging, and home telephone. Therefore, the user may be given the option of attempting various alternative communication media in a determined order. In some embodiments of the present invention, an alternative communication medium may be suggested automatically, or the caller may request an alternative communication medium.

The aforementioned determinations may be the result of a software application stored in memory and/or in conjunction with extensible communication application 160. The user may override the determined communication medium for an individual or a plurality of individuals. For example, if the user knows that an individual is presently available only though text messaging, then the user may opt to send a text message, even though that individual's general preferred communication medium is e-mail.

In step 440, the message is sent to the group of contacts using each contact's determined communication medium via operations of peercast module 140 and extensible communication application 160. Each contact, therefore, will receive the message through his/her preferred communication medium, as determined in the previous step. Communication in step 440 may comprise e-mailing at a certain e-mail address, instant messaging using a certain service, text messaging, and the like.

While the present invention has been described in connection with a series of preferred embodiment, these descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A method for group messaging via a mobile device comprising
receiving message input from a user of the mobile device via an input component of the mobile device;
receiving tag input from the user of the mobile device, wherein the tag is associated with one or more individuals included in a contacts database of the mobile device;
determining a communication medium for each of the one or more individuals associated with the tag; and
sending the message to each of the one or more individuals associated with the tag, wherein the message is sent to each of the one or more individuals utilizing the communication medium of each of the one or more individuals associated with the tag.

2. The method of claim 1, wherein each individual in the contacts database may be associated with one or more tags.

3. The method of claim 1, wherein determining a communication medium is based on at least predefined preference.

4. The method of claim 1, wherein determining a communication medium is based on at least presence.

5. The method of claim 1, wherein determining a communication medium is based on at least location.

6. The method of claim 1, wherein identifying a preferred communication medium further comprises determining each individual's current activity level in using the communication medium.

7. The method of claim 6, further comprising notifying the user of the individual's inactivity on the preferred communication medium.

8. The method of claim 6, further comprising determining an alternative communication medium.

9. The method of claim 8, wherein determining an alternative communication medium is based on at least predefined preference.

10. A system for group messaging comprising
an input/output configured to receive user input concerning a message and a tag;
a contacts database configured to store information concerning one or more individuals, wherein the information includes preferred communication media and tags associated with each of the one or more individuals;
a processor configured to determine a communication medium for each of the one or more individuals associated with the tag; and
a module configured to send the message to a group of one or more individuals associated with the tag using the determined communication medium for each of the one or more individuals.

11. The system of claim 10, wherein the processor is configured to determine a communication medium is based on at least predefined preference.

12. The system of claim 10, wherein the processor is configured to determine a communication medium is based on at least presence.

13. The system of claim 10, wherein the processor is configured to determine a communication medium is based on at least location.

14. The system of claim 10, wherein the contact database is further configured to store information concerning associations between tags and a communication medium belonging to each individual associated with the tag.

15. The system of claim 10, wherein the processor is further configured to determine a current activity level of each individual on the preferred communication medium.

16. The system of claim 15, wherein the user is notified concerning the individual's inactivity in using the determined communication medium.

17. The system of claim 15, wherein the processor is further configured to determine an alternative communication medium.

18. The system of claim 15, wherein the processor is further configured to determine an alternative communication medium based on at least predefined preference.

19. A computer-readable storage medium having embodied thereon a program, the program being executable by a processor to perform a method for group messaging comprising:
receiving message input from a user of the mobile device via an input component of the mobile device;
receiving tag input from the user of the mobile device, wherein the tag is associated with one or more individuals included in a contacts database of the mobile device;
determining a communication medium for each of the one or more individuals associated with the tag; and
sending the message to each of the one or more individuals associated with the tag, wherein the message is sent to each of the one or more individuals utilizing the communication medium of each of the one or more individuals associated with the tag.

20. The computer-readable storage medium of claim 19, wherein the program further comprises executable instructions to cause a determination of an alternative communication medium.
